(19) United States
(12) Patent Application Publication
(10) Pub. No.: US 2015/0213755 A1
(43) Pub. Date: Jul. 30, 2015

(54) WALL STRUCTURE, METHOD OF MANUFACTURING THE SAME, AND DISPLAY PANEL INCLUDING THE WALL STRUCTURE

(71) Applicant: Samsung Display Co., Ltd., Yongin-city (KR)

(72) Inventors: Sung-Kyun PARK, Suwon-si (KR); Jung-Soo LEE, Seoul (KR); Jun CHUN, Yongin-si (KR); Jeong-Min PARK, Seoul (KR); Ji-Hyun KIM, Suwon-si (KR)

(21) Appl. No.: 14/548,111

(22) Filed: Nov. 19, 2014

(30) Foreign Application Priority Data
Jan. 29, 2014 (KR) 10-2014-0011329

(51) Int. Cl. G09G 3/32; B32B 17/06; B32B 38/10; B32B 27/08

(52) U.S. Cl. CPC G09G 3/3225; B32B 27/08; B32B 17/06; B32B 38/10; B32B 2457/20; B32B 2255/26; B32B 2255/20; B32B 2457/206; B32B 2457/202; B32B 2457/204

(57) ABSTRACT

A wall structure, method of manufacturing the same, and display panel including the wall structure are disclosed. In one aspect, the wall structure includes a plurality of first walls each extending in a first direction and a plurality of second walls each extending in a second direction crossing the first direction so as to form an intersection region between the first and second walls. The first and second walls are configured to define and surround a plurality of pixel regions of the display device. Each of the first and second walls has a width greater at the intersection region than the remaining non-intersection region.

### CROSS-REFERENCE TO RELATED APPLICATION(S)

This application claims priority under 35 USC §119 to Korean Patent Applications No. 10-2014-0011329, filed on Jan. 29, 2014 in the Korean Intellectual Property Office (KIPO), the contents of which are incorporated herein in its entirety by reference.

### BACKGROUND

1. Field

The described technology generally relates to a display device, and more particularly, to a wall structure applied to a display device, a method of manufacturing the wall structure, and a display panel including the wall structure.

2. Description of Related Technology

Display panels display visual information based on electrical signals. Example display panels include liquid crystal display (LCD) panels, organic light-emitting diode (OLED) display panels, plasma display panels (PDPs), electrophoretic display (EPD) panels, and electrowetting display (EWD) panels. Display panels can also be classified into flat panel displays (FPDs), rounded display panels, flexible display panels, etc, according to the shape and properties of the display panel.

### SUMMARY OF CERTAIN INVENTIVE ASPECTS

One inventive aspect is a wall structure having improved durability.

Another aspect is a method of manufacturing a wall structure which has improved durability.

Another aspect is a display panel including a wall structure which has improved durability.

Another aspect is a wall structure including a first wall extending in a first direction, and a second wall extending in a second direction different from the first direction, where the width of the first wall and the width of the second wall may be increased toward a center of an intersection region at which the first wall and the second wall intersect.

In example embodiments, the first direction may be perpendicular to the second direction.

In example embodiments, the width of the first wall and the width of the second wall may be increased at the intersection region to a predetermined width.

In example embodiments, the width of the first wall and the width of the second wall may be linearly increased toward the center of the intersection region.

In example embodiments, the width of the first wall and the width of the second wall may be non-linearly increased toward the center of the intersection region.

In example embodiments, the intersection region may have a concave shape toward the center of the intersection region.

In example embodiments, the intersection region may have a convex shape toward the center of the intersection region.

Another aspect is a method of manufacturing a wall structure including forming an insulation layer on the first substrate, forming a photoresist layer on the insulation layer, arranging a mask that exposes a pixel region having a corner-dented shape on the photoresist layer, patterning the photoresist layer to form a plurality of patterns, etching the insulation layer based on the patterns, and removing the patterns.

In example embodiments, the pixel region may have a corner-dented quadrangular shape.

In example embodiments, a corner of the pixel region may be concavely dented toward a center of the pixel region.

In example embodiments, a corner of the pixel region may be convexly dented toward a center of the pixel region.

Another aspect is a display panel including a first substrate, a wall structure configured to separate a plurality of pixels from each other, the pixels being formed on the first substrate, and a second substrate opposite to the first substrate, where the wall structure includes a first wall extending in a first direction and a second wall extending in a second direction different from the first direction, and a width of the first wall and a width of the second wall are increased toward a center of an intersection region at which the first wall and the second wall intersect.

In example embodiments, the first direction may be perpendicular to the second direction.

In example embodiments, the width of the first wall and the width of the second wall may be increased at the intersection region to a predetermined width.

In example embodiments, the width of the first wall and the width of the second wall may be linearly increased toward the center of the intersection region.

In example embodiments, the width of the first wall and the width of the second wall may be non-linearly increased toward the center of the intersection region.

In example embodiments, the intersection region may have a concave shape toward the center of the intersection region.

In example embodiments, the intersection region may have a convex shape toward the center of the intersection region.

Another aspect is a wall structure for a display device, comprising a plurality of first walls each extending in a first direction and a plurality of second walls each extending in a second direction crossing the first direction so as to form an intersection region between the first and second walls, wherein the first and second walls are configured to define and surround a plurality of pixel regions of the display device, wherein each of the first and second walls has a width greater at the intersection region than the remaining non-intersection region.

The first direction can be substantially perpendicular to the second direction. The intersection region can have a center and edges and the width of each of the first walls and the width of each of the second walls can increase from the edges of the intersection region to the center of the intersection region. The width of each of the first walls and the width of each of the second walls can substantially linearly increase from the edges of the intersection region to the center of the intersection region. The widths of each of the first and second walls can non-linearly increase from the edges of the intersection region to the center of the intersection region. The shape of the intersection region viewed from a plan view can have rounded corners that are concave toward the center of the intersection region. The shape of the intersection region viewed from a plan view can have rounded corners that are convex toward the center of the intersection region.

Another aspect is a method of manufacturing a wall structure for a display device, the method comprising providing a first substrate, forming an insulation layer over the first substrate; forming a photoresist layer over the insulation layer; arranging a mask over the photoresist layer, wherein the mask has a plurality of openings and wherein each opening has a shape including indented corners; patterning the photoresist layer so as to form a plurality of patterns; etching the insulation layer; and removing the patterns.

Each of the openings can have a substantially quadrangular shape. The corners of each of the openings can be concavely dented toward the center of the respective opening. The corners of each of the openings can be convexly dented toward the center of the respective opening.

Another aspect is a display panel, comprising a first substrate; a plurality of pixels formed over the substrate; a wall structure separating the pixels from each other; and a second substrate formed over the wall structure, wherein the wall structure includes a plurality of first walls each extending in a first direction and a plurality of second walls each extending in a second direction crossing the first direction, wherein the first walls intersect the second walls at a plurality of intersection regions, and wherein each of the first and second walls has a width greater at the intersection regions than the remaining non-intersection region.

The first direction can be substantially perpendicular to the second direction. The width of each of the first walls and the width of each of the second walls can increase from the edges of each of the intersection regions to the center of each of the intersection regions. The width of each of the first walls and the width of each of the second walls can substantially linearly increase from the edges of each of the intersection regions to the center of each of the intersection regions. The width of each of the first walls and the width of each of the second walls can non-linearly increase from the edges of each of the intersection regions to the center of each of the intersection regions. The shape of each of the intersection regions viewed from a plan view can have rounded corners that are concave toward the center of the intersection region. The shape of each of the intersection regions viewed from a plan view can have rounded corners that are convex toward the center of the intersection region. Each of the intersection regions can have a substantially dodecagonal shape viewed from a plan view. Each of the intersection regions can have a substantially quadrangular shape having truncated corners viewed from a plan view.

Therefore, a wall structure according to at least one embodiment has an improved durability by minimizing the generation of cracks.

In addition, a method of manufacturing the wall structure according to at least one embodiment provides a wall structure having improved durability by a simple process.

Further, a display panel including the wall structure according to at least one embodiment safely protects pixels by including a wall structure which has an improved durability.

### BRIEF DESCRIPTION OF THE DRAWINGS

FIG. 1 is a diagram illustrating a wall structure according to an embodiment.

FIG. 2 is a planar view illustrating the wall structure of FIG. 1.

FIGS. 3A through 3F are planar views illustrating embodiments of an intersection region of the wall structure of FIG. 1.

FIG. 4 is a flow chart illustrating a method of manufacturing a wall structure according to an embodiment.

FIGS. 5 through 10 are cross-sectional views illustrating an example of the manufacturing process of the wall structure by the method of FIG. 4.

FIG. 11 is a cross-sectional view illustrating a display panel including a wall structure according to an embodiment.

### DETAILED DESCRIPTION OF CERTAIN INVENTIVE EMBODIMENTS

Display panels include a plurality of pixels and the pixels can be separated by a wall structure. The standard wall structure includes a plurality of walls separating the pixels from each other. However, these walls are typically vulnerable to stress and cracks may be easily generated due to this stress.

Various example embodiments will be described more fully hereinafter with reference to the accompanying drawings, in which example embodiments are shown. The described technology may, however, be embodied in many different forms and should not be construed as limited to the example embodiments set forth herein. Rather, these example embodiments are provided so that this disclosure will be thorough and complete, and will fully convey the scope of the described technology to those skilled in the art. In the drawings, the sizes and relative sizes of layers and regions may be exaggerated for the sake of clarity. Like numerals refer to like elements throughout.

It will be understood that, although the terms first, second, third etc. may be used herein to describe various elements, these elements should not be limited by these terms. These terms are used to distinguish one element from another. Thus, a first element discussed below could be termed a second element without departing from the teachings of the described technology. As used herein, the term “and/or” includes any and all combinations of one or more of the associated listed items.

It will be understood that when an element is referred to as being “connected” or “coupled” to another element, it can be directly connected or coupled to the other element or intervening elements may also be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the described technology. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which the described technology belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. The term “substantially” as used in this disclosure can include the meanings of completely, almost completely, or to any significant degree in some applications and in accordance with the understanding of those skilled in the art.

Referring to FIGS. 1 through 3F, the wall structure 100 includes a first wall 110 and a second wall 130. For example, the wall structure 100 may serve as a structure to separate pixels to form a cell unit in the display panel. A cell region DA formed by intersection between the first wall 110 and the second wall 130 corresponds to the pixel region of the display panel. The pixel is formed in the pixel region DA (i.e., the cell region). In some embodiments, the pixel includes an organic light-emitting diode (OLED).

The first and second walls 110 and 130 are respectively extending in predetermined directions. For example, the first wall 110 may be extending in a first direction D1 and the second wall 130 may be extending in a second direction D2. In example embodiments, the wall structure 100 further includes a third wall which is extending in the first direction D1 and is separated from the first wall 110. Further, the wall structure 100 may include a fourth wall which is extending in the first direction D1 and is separated from the first wall 110 and the third wall. Accordingly, the wall structure 100 may include a plurality of walls extending in the first direction D1. Herein the walls extending in the first direction D1 are referred to as the first walls 110 for convenience of description. In example embodiments, the wall structure 100 further includes a fifth wall which is extending in the second direction D2 and is separated from the second wall 130. Further the wall structure 100 may include a sixth wall which is extending in the second direction D2 and is separated from the second wall 130 and the fifth wall. Accordingly, the wall structure 100 may include a plurality of walls extending in the second direction D2. Herein the walls extending in the second direction D2 are referred to as the second walls 130 for convenience of description. In example embodiments, the first direction D1 is different from the second direction D2. Thus, in these embodiments, the first direction D1 crosses the second direction D2. For example, the first direction D1 may be substantially perpendicular to the second direction D2 as illustrated in FIGS. 1 through 3F. However, the first and second directions D1 and D2 are not limited to the directions illustrated in FIGS. 1 through 3F, and the angle between the first and second directions D1 and D2 can be determined according to various design conditions.

The first walls 110 and the second walls 130 are formed on a substrate. For example, the first and second walls 110 and 130 can be formed on a first substrate of the display panel. The first substrate may be a base substrate supporting the pixels of the display panel. In an example embodiment, the first substrate has a substantially flat surface. In some embodiments, the first and second walls 110 and 130 have substantially the same height from the first substrate. In another example embodiment, the first substrate has a curved surface. In this embodiment, the first and second walls 110 and 130 have substantially the same height along the curved surface. In still another example embodiment, the first substrate is flexible and the first and second walls 110 and 130 are also flexible.

The first and second walls 110 and 130 intersect each other. An intersection region 150 is formed by the intersection between the first and second walls 110 and 130.

In some embodiments, the first walls 110 each have a first width W1 and the second walls 130 each have a second width W2. In an example embodiment, the first width W1 is substantially the same as the second width W2. In another example embodiment, the first walls 110 each have different widths and the second walls 130 each have different widths. In example embodiments, the first width W1 and the second width W2 increase at the intersection region 150. For example, the first width W1 may be increased to a third width W3 toward the center of the intersection region 150 and the second width W2 may be increased to a fourth width W4 toward the center of the intersection region 150. In these embodiments, since the first width W1 and the second width W2 are increased toward the center of the intersection region 150, the corners of the intersection region 150, as viewed from a planar view, are physically strengthened, increasing the rigidity of the corners.

If the first walls and the second walls are formed to have substantially constant widths over the entire substrate, cracks may be generated at the intersections between the first and second walls 110 and 130. For example, the intersection regions may have a sharp corner based on a planar view of the wall structure. Since these corners can be weakened from stress, cracks may be easily generated during the manufacturing process of the wall structure. The cracks may be generated by breaking the molecular bonding in the wall material when stress is concentrated on a specific point of the wall material. Stress may be concentrated on a specific portion (e.g., corner) which has a small curvature. Accordingly, cracks may be easily generated at corners where stress is easily concentrated. When a crack is generated in the wall structure, the crack may be grown and propagated by concentration of stress at a tip of the crack which has small curvature. As a result, the wall structure may be fractured by the growth and propagation of the crack. Further the display panel including the standard wall structure which is not physically strong may have a deteriorated durability and reliability. However, according to at least one embodiment, the wall structure 100 includes the first and second walls 110 and 130 respectively having widths W1 and W2 that increase toward the center of the intersection region 150, so that the generation of cracks can be prevented. Since the corner of the intersection regions 150 are strengthened, the physical strength thereof can be improved. Since the stress may be distributed due to the geometrical shape of the intersection region 150, the generation of cracks can be prevented.

In some embodiments, the widths W1 and W2 of the walls 110 and 130 increase linearly or non-linearly toward the center of the intersection region 150.

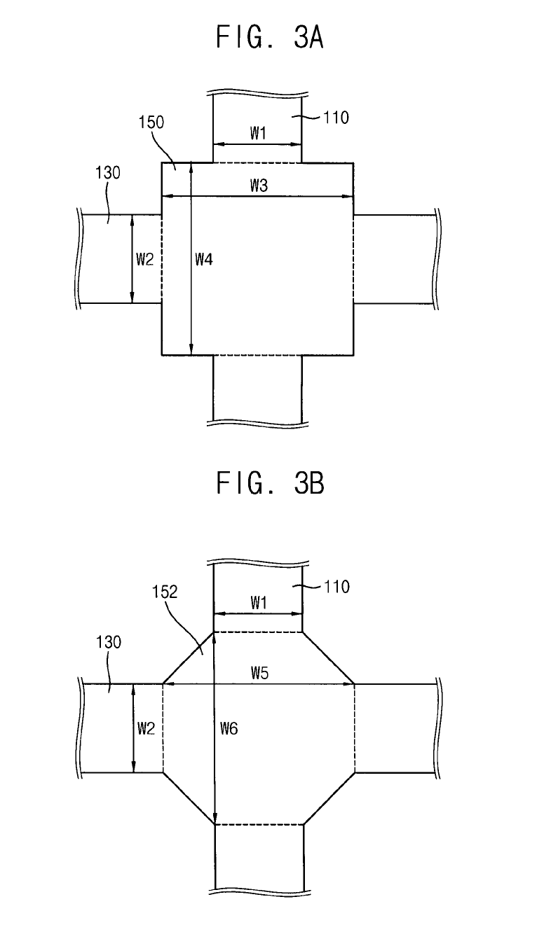

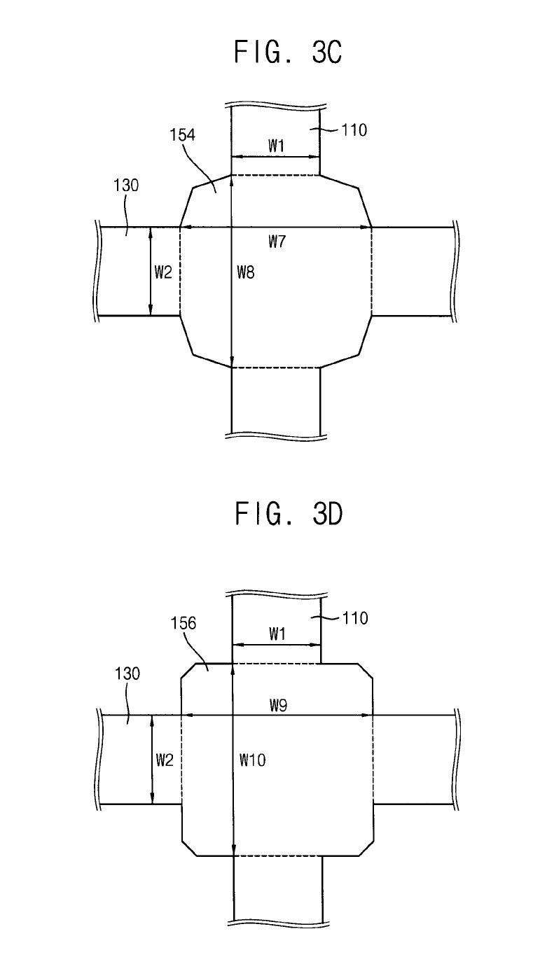

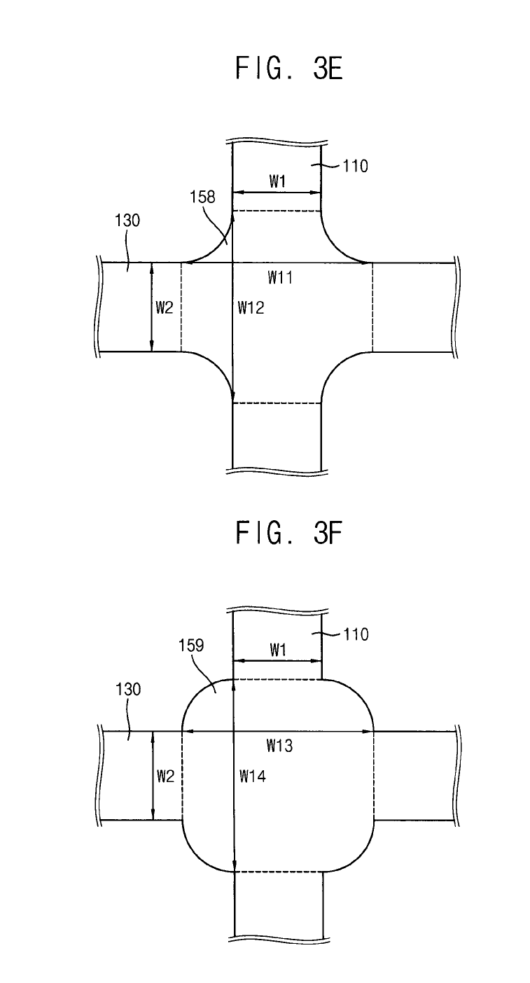

In an example embodiment, as illustrated in FIG. 3A, the first width W1 of the first wall 110 is non-linearly increased to a third width W3 and the second width W2 of the second wall 130 is non-linearly increased to a fourth width W4. The intersection region 150 of the wall structure 100 is substantially quadrangular shape based on a planar view of the wall structure 100. For example, the third width W3 may be about two times wider than the first width W1 and the fourth width W4 may be about two times wider than the second width W2. Since the intersection region 150 of the wall structure 100 has a comparatively broad area, the physical strength of the intersection region 150 is improved.

In another example embodiment, as illustrated in FIG. 3B, the first width W1 of the first wall 110 is linearly increased to the fifth width W5 and the second width W2 of the second wall 130 is linearly increased to the sixth width W6. The intersection region 152 of the wall structure 100 has a substantially octagonal shape based on a planar view of the wall structure 100. For example, the fifth width W5 may be about two times wider than the first width W1 and the sixth width W6 may be about two times wider than the second width W2. Since the intersection region 152 of the wall structure 100 has a comparatively broad area, the physical strength of the intersection region 152 is improved. Further, the number of corners of the intersection region 152 is increased and the angle of each corner is increased compared to the standard wall structure, so that the concentration of stress can be relieved due to the geometrical shape of the intersection region 152.

In another example embodiment, as illustrated in FIG. 3C, the first width W1 of the first wall 110 is non-linearly increased to a seventh width W7 and the second width W2 of the second wall 130 is non-linearly increased to a eighth width W8. The intersection region 154 of the wall structure 100 has a substantially dodecagonal shape based on a planar view of the wall structure 100. For example, the seventh width W7 may be about two times wider than the first width W1 and the eighth width W8 may be about two times wider than the second width W2. Since the intersection region 154 of the wall structure 100 has a comparatively broad area, the physical strength of the intersection region 154 is improved. Further, the number of corners of the intersection region 154 is increased and the angle of each corner is increased with respect to the standard wall structure, so that the concentration of stress can be relieved due to the geometrical shape of the intersection region 154.

In still another example embodiment, as illustrated in FIG. 3D, the first width W1 of the first wall 110 is non-linearly increased to a ninth width W9 and the second width W2 of the second wall 130 is non-linearly increased to a tenth width W10. The intersection region 156 of the wall structure 100 has a substantially quadrangular shape having truncated corners based on a planar view of the wall structure 100. For example, the shape of the intersection region 156 may be a substantially quadrangular shape which has obliquely truncated corners. In example embodiments, the ninth width W9 is about two times wider than the first width W1 and the tenth width W10 is about two times wider than the second width W2. Since the intersection region 156 of the wall structure 100 has a comparatively broad area, the physical strength of the intersection region 156 is improved. Further, the number of corners of the intersection region 156 is increased and the angle of each corner is increased with respect to the standard wall structure, so that the concentration of stress can be relieved due to the geometrical shape of the intersection region 156.

In yet another example embodiment, as illustrated in FIG. 3E, the first width W1 of the first wall 110 is non-linearly increased to a eleventh width W11 and the second width W2 of the second wall 130 is non-linearly increased to a twelfth width W12. The intersection region 158 of the wall structure 100 may have a substantially quadrangular shape having truncated corners based on a planar view of the wall structure 100. For example, the shape of the intersection region 158 may be a substantially quadrangular shape in which the corners are concavely dented toward the center of the intersection region 158. In example embodiments, the eleventh width W11 is about two times wider than the first width W1 and the twelfth width W12 is about two times wider than the second width W2. Since the intersection region 158 of the wall structure 100 has a comparatively broad area, the physical strength of the intersection region 158 can be improved. Further, the shape of the intersection region 158 has gently dented corners, so that the concentration of the stress may be relieved due to the geometrical shape of the intersection region 158.

In a further example embodiment, as illustrated in FIG. 3F, the first width W1 of the first wall 110 is non-linearly increased to a thirteenth width W13 and the second width W2 of the second wall 130 is non-linearly increased to a fourteenth width W14. The intersection region 159 of the wall structure 100 has a substantially quadrangular shape having rounded corners based on a planar view of the wall structure 100. For example, the shape of the intersection region 159 may be a substantially quadrangular shape having rounded corners convex toward the center of the intersection region 159. In example embodiments, the thirteenth width W13 is about two times wider than the first width W1 and the fourteenth width W14 is about two times wider than the second width W2. Since the intersection region 159 of the wall structure 100 has a comparatively broad area, the physical strength of the intersection region 159 can be improved. Further, the shape of the intersection region 159 has gently rounded corners, so that the concentration of the stress can be relieved due to a geometrical shape of the intersection region 159.

The widths W3 through W14 which are increased at the intersection region 150, 152, 154, 156, 158, and 159 may have a predetermined length so as to not significantly reduce the area of the pixel region DA of the display panel. When the area of the pixel region DA is significantly reduced, the image quality of the display panel may be degraded. Thus, the first and second widths W1 and W2 can be respectively increased to a suitable length. In example embodiments, the first and second widths W1 and W2 are increased to double the initial widths W1 and W2 at the intersection region 150, 152, 154, 156, 158, and 159. Nevertheless, the area of the pixel region DA is not significantly reduced. For example, as illustrated in FIG. 3A, when the first width W1 and the second width W2 are about 12 micro-meters (μm) and the first width W1 and the second width W2 are increased to the third width W3 and the fourth width W4 which are about 24 μm, the pixel region DA having an area of about 160 μm×about 160 μm may be reduced by only about 0.66%. Further, as illustrated in FIG. 3B, when the first and second widths W1 and W2 are about 12 μm and the first and second widths W1 and W2 are respectively increased to the fifth and sixth widths W5 and W6 which are about 24 μm, the pixel region DA having an area of about 160 μm×about 160 μm may be reduced by only about 0.33%. Similarly, as illustrated in FIGS. 3C through 3F, even though the first and second widths W1 and W2 are increased at the intersection regions 154, 156, 158, and 159, the reduction of the area of the pixel region DA is less than about 1%. Therefore, the reduction of the pixel region DA of the display panel is extremely small and the area of the pixel region DA is substantially maintained.

In example embodiments, the first and second walls 110 and 130 are formed of substantially the same material. For example, the first and second walls 110 and 130 can be formed of an organic material or an inorganic material. Accordingly, the first and second walls 110 and 130 can be simultaneously formed.

In an example embodiment, the first and second walls 110 and 130 are formed of an inorganic material (e.g., silicon oxide (SiOx), silicon nitride (SiNx), silicon oxynitride, etc). In another example embodiment, the first and second walls 110 and 130 are formed of an organic material. For example, the first and second walls 110 and 130 may be formed of an organic resin. Since the organic resin is elastic, the wall structure 100 can serve as a buffering member between the first substrate and the second substrate. Further, the first and second walls 110 and 130 may be formed of a flexible organic resin. Since the flexible organic resin is flexible, the wall structure 100 can be used in a flexible display panel or a rounded display panel. For example, the organic resin may include an acryl-based resin (e.g., ethylhexyl acrylate, ethoxyethyl acrylate, isobutyl acrylate, octadecyl acrylate, ethyl acrylate, Lauryl acrylate, hexafluoroisopropyl acrylate, bisphenol A dimeth acrylate, trimethylpropane propoxylate tri acrylate, methoxy polyethylene glycol acrylate, phenoxy polyethylene glycol acrylate or a combination thereof), an epoxy-based resin (e.g., bisphenol-A type epoxy resin, bisphenol-F type epoxy resin, novolac type epoxy resin, brominated epoxy resin, cycloaliphatic epoxy resin, rubber modified epoxy resin, aliphatic polyglycidyl type epoxy resin, glycidyl amine type epoxy resin, biphenyl type epoxy resin, naphthalene type epoxy resin and tris-phenol methane type epoxy resin or a combination thereof), a phenol-based resin, a polyamide-based resin, a polyimide-based resin, an unsaturated polyester-based resin, a polyphenylene-based resin, a polyphenylene sulfide-based resin, or a benzocyclobutene-based resin.

In example embodiments, the first and second walls 110 and 130 are respectively formed of different materials. For example, the first wall 110 may be formed of an inorganic material (e.g., silicon oxide, silicon nitride, silicon oxynitride, etc) and the second wall 130 may be formed of an organic material (e.g., an acryl-based resin, an epoxy-based resin, a phenol-based resin, a polyamide-based resin, a polyimide-based resin, an unsaturated polyester-based resin, a polyphenylene-based resin, a polyphenylene sulfide-based resin or a benzocyclobutene-based resin, etc).

In example embodiments, the first and second walls 110 and 130 further include a moisture absorbent or an absorbent. Since the moisture absorbent or the absorbent absorbs moisture, the wall structure 100 can protect the pixels in the pixel region DA from denaturation caused by exposure to external moisture. For example, the moisture absorbent or the absorbent may include sodium chloride (NaCl), calcium chloride (CaCl₂), calcium carbonate (NaCO3), silicic anhydride, etc, as a capsule type. As the total surface area of the capsule type moisture absorbent or the absorbent increases, the dehumidification efficiency of the moisture absorbent or the absorbent can be maximized.

As described above, since the area of the intersection regions 150, 152, 154, 156, 158, and 159 of the wall structure 100 becomes larger based on a planar view of the wall structure 100, the physical strength of the intersection regions 150, 152, 154, 156, 158, and 159 can be improved. Further, the intersection regions 152, 154s and 156 have many corners and the intersection region 158 and 159 have curved corners, so that the concentration of stress can be substantially prevented due to the geometry of the intersection regions 152, 154, 156, 158, and 159. Therefore, the wall structure 100 can have improved durability by reducing the generation of cracks.

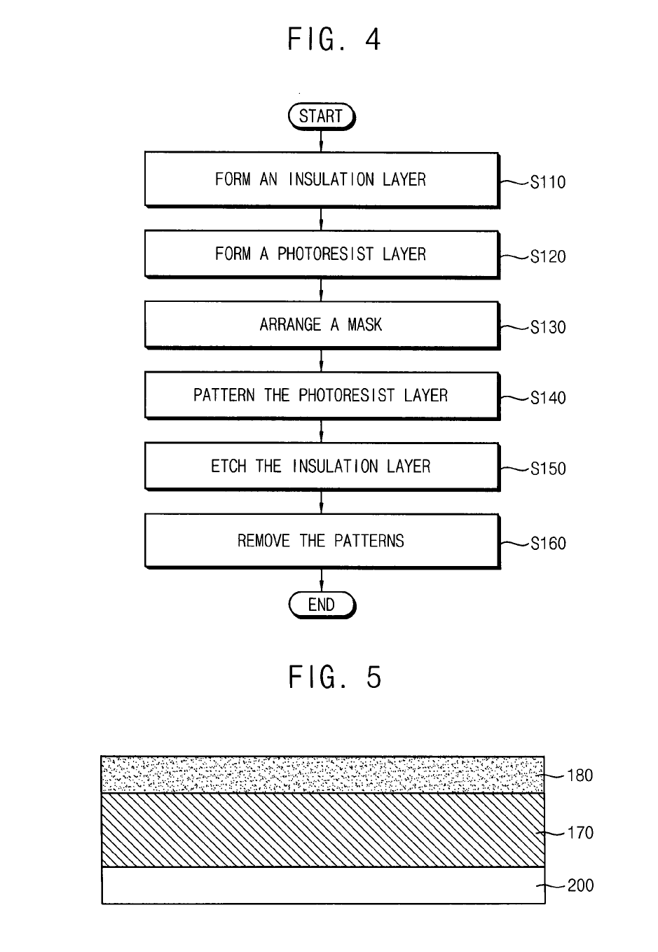

FIG. 4 is a flow chart illustrating a method of manufacturing a wall structure according to example embodiments. FIGS. 5 through 10 are cross-sectional views illustrating an example of manufacturing process of the wall structure by the method of FIG. 1.

Referring to FIGS. 5 through 10, the method of FIG. 4 includes forming an insulation layer on the first substrate (S110), forming a photoresist layer on the insulation layer (S120), arranging a mask on the photoresist layer (S130), patterning the photoresist layer which is exposed by the mask to form patterns (S140), etching the insulation layer based on the patterns (S150), and removing the patterns (S160).

As illustrated in FIG. 5, the insulation layer 170 is formed on the first substrate 200 (S110). In an example embodiment, the insulation layer 170 is formed of an inorganic material (e.g., silicon oxide, silicon nitride, silicon oxynitride, etc). In another example embodiment, the insulation layer 170 is formed of an organic material (e.g., acryl-based resin, an epoxy-based resin, a phenol-based resin, a polyamide-based resin, a polyimide-based resin, an unsaturated polyester-based resin, a polyphenylene-based resin, a polyphenylene sulfide-based resin or a benzocyclobutene-based resin, etc). For example, when the insulation layer 170 is formed of organic material, the insulation layer 170 may further include an addition agent. For example, the insulation layer 170 may include a thermosetting or a photocurable hardener and may further include a moisture absorbent or an absorbent. The insulation layer 170 may be formed by coating the organic or inorganic material on the first substrate 200. The coating may be performed by spin coating, spray coating, dipping method, inkjet printing, etc.

In example embodiments, the photoresist layer 180 is formed on the insulation layer 170 (S120). The photoresist layer 180 may be formed by coating a photoresist on the insulation layer 170. For example, the coating may be performed by spin coating, spray coating, dipping method, inkjet printing, etc. For example, the photoresist layer 180 may be formed using a positive photoresist. The positive photoresist may be removed in exposed region by developing the exposed region. The photoresist layer 180 may include a resin for improving the polarity by reaction with an acid. For example, the photoresist layer 180 may include a resin having acid resolvable protecting group and a chemically amplified photoresist having poly alkylen glycol (PAG). In example embodiments, after coating the insulation layer 170 and the photoresist layer 180 on the first substrate 200, a preparatory dry is performed. For example, the insulation layer 170 and the photoresist layer 180 may be dried at a temperature ranging from about 60° C. through 160° C. If the preparatory dry is performed, follow-up process may be more easily performed.

In example embodiments, the insulation layer 170 and the photoresist layer 180 are formed by mixing the materials of each layer with each other to form a single layer. The insulation layer 170 including the photoresist may be formed by coating a mixture of organic resin and photoresist on the first substrate 200.

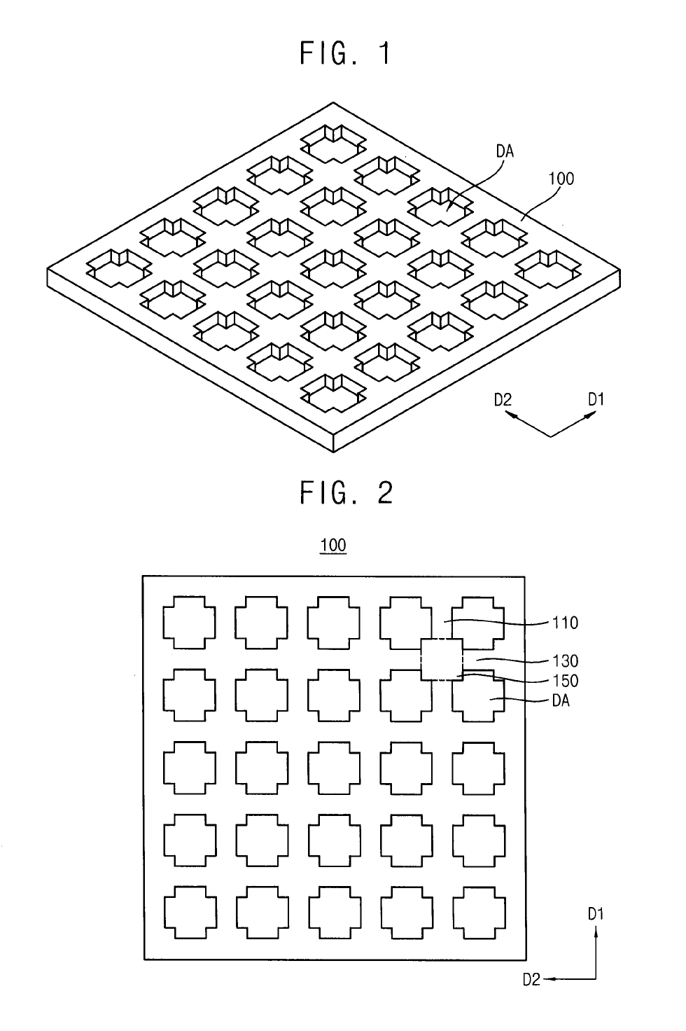

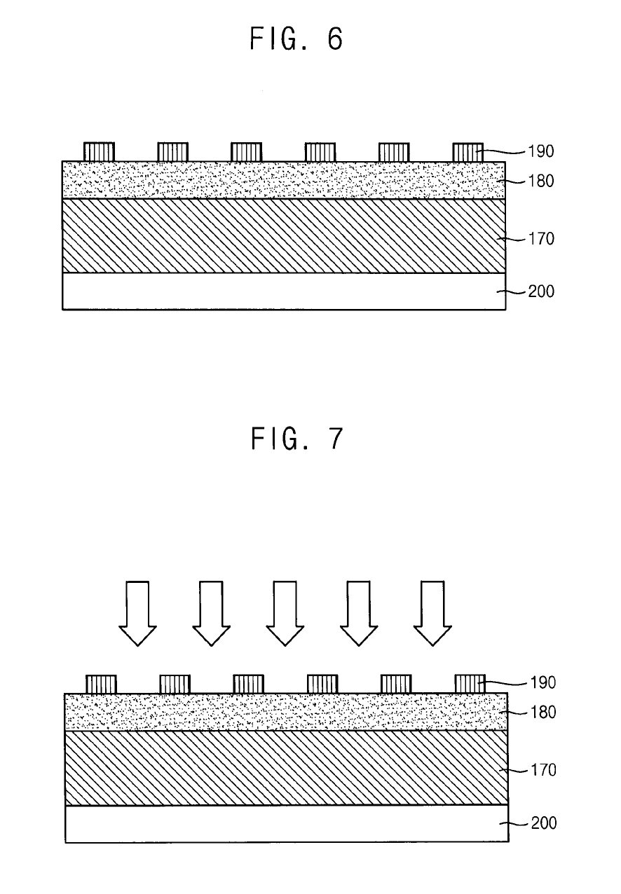

As illustrated in FIG. 6, the mask 190 is arranged on the photoresist layer 180 (S130). The mask 190 includes an exposing region in which light is transmitted and a blocking region in which light is not transmitted. If the photoresist is positive photoresist, the exposing region corresponds to the pixel region DA. Since the photoresist exposed through the exposing region (i.e., pixel region DA) is removed, the insulation layer 170 in the pixel region DA is etched. In example embodiments, the exposing region (i.e., pixel region DA) of the mask 190 has a corner-dented shape based on a planar view. For example, the exposing region (i.e., pixel region DA) may have a quadrangular shape of which corners are dented toward the center of the pixel region DA. As illustrated in FIGS. 2 and 3A, the corners of the exposing region (i.e., pixel region DA) may be orthogonally dented. As illustrated in FIG. 3B, the corners of the exposing region (i.e., pixel region DA) may be obliquely dented. As illustrated in FIGS. 3C and 3D, the corners of the exposing region (i.e., pixel region DA) may be obliquely and/or orthogonally dented. As illustrated in FIG. 3E, the corners of the exposing region (i.e., pixel region DA) may be convexly dented toward the center of the pixel region DA. As illustrated in FIG. 3F, the corners of the exposing region (i.e., pixel region DA) may be concavely dented toward the center of the pixel region DA. Since the geometrical shapes of the pixel region DA were described in detail with reference to FIGS. 2 and 3A through 3F, duplicated descriptions thereof will not be repeated.

As illustrated in FIG. 7, the method of FIG. 4 includes exposing the mask 190 to light. For example, high intensity ultraviolet light may be used as the exposure light. The photoresist layer 180 at the exposing region of the mask 190 may have an increased solubility for a specific solute or a specific chemical bonding of the photoresist layer 180 may be decomposed by exposure to the light.

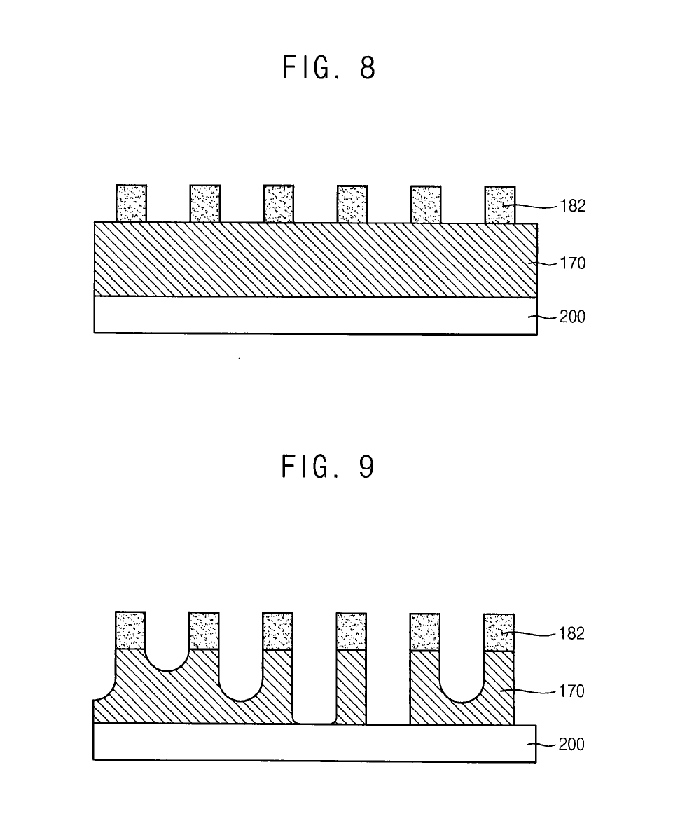

As illustrated in FIG. 8, after removing the mask 190, the photoresist layer 180 is developed. A developer may be selected in accordance with the type of the photoresist. For example, when a positive photoresist is used, a positive type developer may be used. The photoresist layer 180 may be patterned to form patterns 182 by developing the photoresist layer 180 (S140). For example, a crack may be generated in the insulation layer 170 by elimination of some of the photoresist layer 180 during development. Especially, cracks may be more easily generated in the insulation layer 170 at the corners of the pixel region DA. However, according to at least one embodiment, the patterns 182 are formed to have corners dented toward the center of the pixel region DA, so that the generation of crack at the corners can be prevented. Further, the wall at the corners (i.e., the intersection region) has a large thickness, so that the durability of the wall structure 100 can be improved.

As illustrated in FIG. 9, the insulation layer 170 exposed through the patterns 182 is etched (S150). Since the patterns 182 block etching of the insulation layer 170 under the patterns 182, the insulation layer 170 is patterned to substantially the same pattern as the patterns 182. The insulation layer 170 may be etched by wet etching using an acidic etchant (e.g., hydrofluoric acid (HF), hydrochloric acid (HCl), etc), or dry etching using a reactive-ion or plasma.

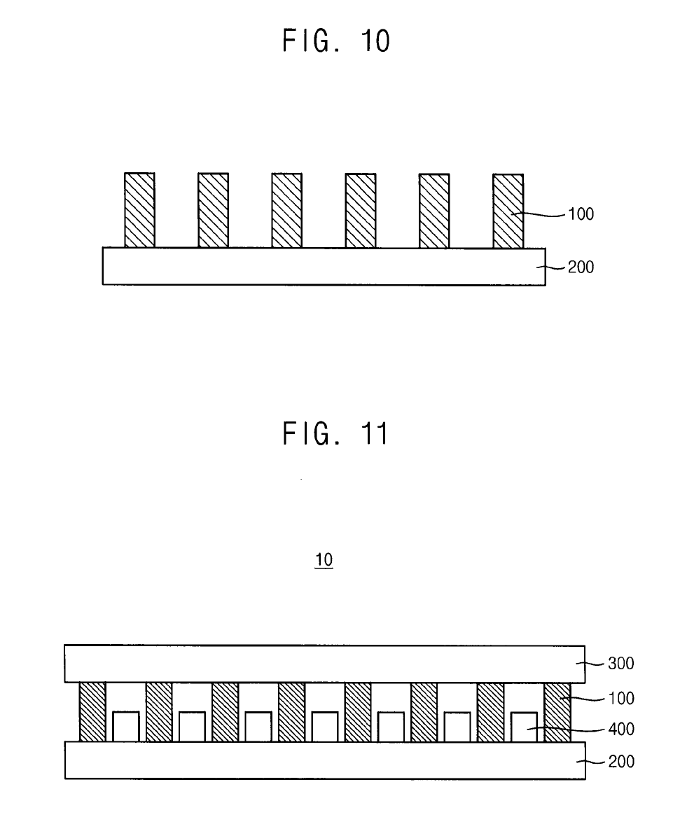

As illustrated in FIG. 10, the wall structure 100 is manufactured by removing the patterns 182 (S160). The patterns 182 may be removed by a wet method using liquid remover or a dry method (e.g., ashing process).

As described above, the generation of cracks is minimized, so that the wall structure 100 can have an improved durability. Additionally, the wall structure 100 can be easily manufactured by altering the exposing region (i.e., pixel region DA) of the mask 190.

FIG. 11 is a cross-sectional view illustrating a display panel including a wall structure according to an embodiment.

Referring to FIG. 11, the display panel 10 includes a first substrate 200, a plurality of pixels 400, a wall structure 100, and a second substrate 300. The display panel 10 is a panel that can display visual information based on electrical signals. For example, the display panel may be one of a liquid crystal display (LCD) panel, an organic light-emitting diode (OLED) display panel, a plasma display panel (PDP), an electrophoretic display (EPD) panel, or electrowetting display (EWD) panel according to technology used to display the visual information. Further, the display panel 10 may be a flat panel display, a rounded display panel, or a flexible display panel according to the design requirements for the appearance of the display panel.

The first substrate 200 supports the pixels 400 and may be a main substrate of the display panel 10. The first substrate 200 may be a glass substrate or a plastic substrate to provide physical strength and chemical stability. When the first substrate 200 is a glass substrate, the first substrate 200 may include silicon oxide (SiOx). When the first substrate 200 is a plastic substrate, the first substrate 200 may include polyacrylate (PAR), polyetherimide (PEI), polyethylen terephthalate (PET), polyethylen naphthalate (PEN), polyphenylene sulfide (PPS), Polyimide, polycarbonate (PC), etc.

The pixels 400 can display the visual information and are formed on the first substrate 200. The pixels 400 can include various pixel elements according to the type of the display panel. For example, the pixels 400 may include liquid crystal, organic light-emitting diodes, plasma, electrophoretic particles, etc. The pixels 400 are separated into cell units and the pixels 400 may respectively include sub pixels (e.g., red sub pixel, green sub pixel, and blue sub pixel). In an example embodiment, the sub pixels include a pixel electrode, a common electrode, a liquid crystal, a color filter, and a backlight unit. In this embodiment, the display panel 10 is a liquid crystal display panel. In another example embodiment, the sub pixels include a pixel electrode, an opposite electrode, and an organic light-emitting layer. In this embodiment, display panel 10 is an organic light-emitting diode (OLED) display panel. In still another example embodiment, the sub pixels include an address electrode, a phosphor layer, a dielectric layer, a scan electrode, and a sustain electrode. In this embodiment, the display panel 10 is a plasma display panel. In still yet another example embodiment, the sub pixels include a pixel electrode, a common electrode, and electrophoretic particles. In this embodiment, the display panel 10 is an electrophoretic display panel.

The second substrate 300 is opposite to the first substrate 200 and protects the pixels 400 from the external environment. The second substrate 300 is formed of transparent glass or transparent plastic to easily transmit the light emitted by the pixels 400.

The wall structure 100 separates the pixels 400 from each other. For example, the wall structure 100 may include a plurality of intersecting walls. The walls intersect to form a plurality of pixel regions. The pixels 400 are formed in the pixel region. The walls extend in a predetermined direction. For example, the walls may include first walls extending in a first direction and second walls extending in a second direction. The first walls and the second walls intersect at an intersection region. According to at least one embodiment, the width of the first wall and the width of the second wall increase at the intersection region. For example, the width of the first wall and the width of the second wall may be increased toward the center of the intersection region to a predetermined width. The width of the first wall and the width of the second wall may be linearly or non-linearly increased. The shape of the intersection region may be changed based on the change in the width of the first and second walls. Stress concentrated on the intersection region can be relieved due to the shape of the intersection region. Accordingly, the generation of cracks in the wall structure 100 can be minimized and the durability of the display panel 10 can be improved. Since the shape of the intersection region is substantially same as that of the FIGS. 1 through 3F, duplicated descriptions thereof will not be repeated.

As described above, according to at least one embodiment, the wall structure 100 of the display panel 10 includes a plurality of walls having widths that increase toward the center of the intersection regions. The stress concentrated on a corner of the intersection region can be relieved due to the shape of the intersection region. Therefore, the generation of cracks at the corners of the wall structure 100 can be minimized and the durability of the display panel 10 can be improved. Since the display panel 10 includes the wall structure 100 having improved durability, the pixels 400 in the display panel 10 may be stably protected.

Although a few example embodiments (e.g., the wall structure, the method of manufacturing the wall structure, and the display panel including the wall structure) have been described, those skilled in the art will readily appreciate that many modifications are possible in the example embodiments without materially departing from the novel teachings and advantages of the described technology.

The described technology can be applied to any display device. For example, the described technology may be applied to a liquid crystal display (LCD) panel, an organic light-emitting diode (OLED) display panel, a plasma display panel (PDP), an electrophoretic display (EPD) panel, an electrowetting display (WED) panel, etc.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the invention as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A wall structure for a display device, comprising:
a plurality of first walls each extending in a first direction; and
a plurality of second walls each extending in a second direction crossing the first direction so as to form an intersection region between the first and second walls, wherein the first and second walls are configured to define and surround a plurality of pixel regions of the display device,
wherein each of the first and second walls has a width greater at the intersection region than the remaining non-intersection region.

2. The wall structure of claim 1, wherein the first direction is substantially perpendicular to the second direction.

3. The wall structure of claim 1, wherein the intersection region has a center and edges and wherein the width of each of the first walls and the width of each of the second walls increases from the edges of the intersection region to the center of the intersection region.

4. The wall structure of claim 3, wherein the width of each of the first walls and the width of each of the second walls substantially linearly increases from the edges of the intersection region to the center of the intersection region.

5. The wall structure of claim 3, wherein the widths of each of the first and second walls non-linearly increase from the edges of the intersection region to the center of the intersection region.

6. The wall structure of claim 5, wherein the shape of the intersection region viewed from a plan view has rounded corners that are concave toward the center of the intersection region.

7. The wall structure of claim 5, wherein the shape of the intersection region viewed from a plan view has rounded corners that are convex toward the center of the intersection region.

8. The wall structure of claim 5, wherein the intersection region has a substantially dodecagonal shape viewed from a plan view.

9. The wall structure of claim 5, wherein the intersection region has a substantially quadrangular shape having truncated corners viewed from a plan view.

10. A method of manufacturing a wall structure for a display device, the method comprising:
providing a first substrate;
forming an insulation layer over the first substrate;
forming a photoresist layer over the insulation layer;
arranging a mask over the photoresist layer, wherein the mask has a plurality of openings and wherein each opening has a shape including indented corners;
patterning the photoresist layer so as to form a plurality of patterns;
etching the insulation layer; and
removing the patterns.

11. The method of claim 10, wherein each of the openings has a substantially quadrangular shape.

12. The method of claim 10, wherein the corners of each of the openings is concavely dented toward the center of the respective opening.

13. The method of claim 10, wherein the corners of each of the openings is convexly dented toward the center of the respective opening.

14. A display panel, comprising:
a first substrate;
a plurality of pixels formed over the substrate;
a wall structure separating the pixels from each other; and
a second substrate formed over the wall structure,
wherein the wall structure includes a plurality of first walls each extending in a first direction and a plurality of second walls each extending in a second direction crossing the first direction,
wherein the first walls intersect the second walls at a plurality of intersection regions, and
wherein each of the first and second walls has a width greater at the intersection regions than the remaining non-intersection region.

15. The display panel of claim 14, wherein the first direction is substantially perpendicular to the second direction.

16. The display panel of claim 14, wherein the width of each of the first walls and the width of each of the second walls increases from the edges of each of the intersection regions to the center of each of the intersection regions.

17. The display panel of claim 16, wherein the width of each of the first walls and the width of each of the second walls substantially linearly increases from the edges of each of the intersection regions to the center of each of the intersection regions.

18. The display panel of claim 16, wherein the width of each of the first walls and the width of each of the second walls non-linearly increase from the edges of each of the intersection regions to the center of each of the intersection regions.

19. The display panel of claim 18, wherein the shape of each of the intersection regions viewed from a plan view has rounded corners that are concave toward the center of the intersection region.

20. The display panel of claim 18, wherein the shape of each of the intersection regions viewed from a plan view has rounded corners that are convex toward the center of the intersection region.
